(19) United States
(12) Patent Application Publication
(10) Pub. No.: US 2026/0212642 A1
(43) Pub. Date: Jul. 23, 2026

(54) INFORMATION PROCESSING APPARATUS

(71) Applicant: NEC Corporation, Tokyo (JP)

(72) Inventor: Yuta SHIMIZU, Tokyo (JP)

(73) Assignee: NEC Corporation, Tokyo (JP)

(21) Appl. No.: 19/443,171

(22) Filed: Jan. 8, 2026

(30) Foreign Application Priority Data
Jan. 23, 2025 (JP) 2025-009745

(51) Int. Cl. G06V 10/75; G06V 10/70; G06V 10/72; G06V 10/764; G06V 10/774

(52) U.S. Cl. CPC G06V 10/758; G06V 10/72; G06V 10/764; G06V 10/774; G06V 10/87

(57) ABSTRACT

An information processing apparatus includes a calculation unit that calculates, according to a plurality of processing results for image data using a predetermined first model, characteristic information indicating a detection characteristic of the first model, and a selection unit that selects, according to a calculation result by the calculation unit, a second model that performs predetermined processing on the image data.

### INCORPORATION OF BASIC APPLICATION

The present invention claims the benefit of the priority of Japanese Patent Application No. 2025-009745 filed on January 23, 2025 in Japan, the contents of which are incorporated herein by reference in its entirety.

### TECHNICAL FIELD

The present invention relates to an information processing apparatus, an information processing method, and a storage medium.

### BACKGROUND ART

A technology used when predetermined processing such as object detection is performed on image data is known.

For example, PTL 1 describes an object identification apparatus including a foreground extraction unit, a state extraction unit, an identification model selection unit, and an identification unit. According to PTL 1, the foreground extraction unit extracts a foreground such as a region related to a moving object from an input image by using a foreground extraction model or the like. The state extraction unit extracts, based on a foreground extraction result, a state of the foreground such as a movement trajectory feature, an area variation feature, and an appearance feature. Thereafter, the identification model selection unit selects, based on the extracted state, one or a plurality of identification models by using a selection model. The identification unit then identifies the moving object included in the input image by using the selected identification model.

PTL 1: WO 2021/130856 A1

### SUMMARY

First processing such as foreground extraction may be performed a plurality of times, such as detecting a plurality of objects in response to input of image data. In such a case, it is assumed that an appropriate model can be selected in consideration of a plurality of states and the like over the entire image data by selecting a second model according to a plurality of processing results. However, the technology described in PTL 1 focuses only on a specific object, and it is difficult to perform selection according to a plurality of states as described above. As a result, there is a problem that it may be difficult to select a model.

An object of the present disclosure is to provide an information processing apparatus, an information processing method, and a storage medium that can solve the above-described problem.

In order to achieve such an object, an information processing apparatus in the present disclosure adopts a configuration including

a calculation unit that calculates, according to a plurality of processing results for image data using a predetermined first model, characteristic information indicating a detection characteristic of the first model, and

a selection unit that selects, according to a calculation result by the calculation unit, a second model that performs predetermined processing on the image data.

An information processing method in the present disclosure adopts a configuration in which

an information processing apparatus

calculates, according to a plurality of processing results for image data using a predetermined first model, characteristic information indicating a detection characteristic of the first model, and

selects, according to a calculation result, a second model that performs predetermined processing on the image data.

A storage medium in the present disclosure is

a computer readable storage medium storing a program for causing an information processing apparatus to achieve processing of

calculating, according to a plurality of processing results for image data using a predetermined first model, characteristic information indicating a detection characteristic of the first model, and

selecting, according to a calculation result, a second model that performs predetermined processing on the image data.

According to each configuration as described above, a second model can be more appropriately selected.

### BRIEF DESCRIPTION OF THE DRAWINGS

FIG. 1 is a diagram illustrating an outline of a detection system in a first example embodiment of the present disclosure;

FIG. 2 is a block diagram illustrating a configuration example of a detection device;

FIG. 3 is a diagram for describing a processing example when characteristic information is calculated;

FIG. 4 is a diagram illustrating an example of information used at the time of selection;

FIG. 5 is a diagram illustrating an output example by an output unit;

FIG. 6 is a flowchart illustrating an operation example of the detection device;

FIG. 7 is a diagram illustrating an outline of a detection system in a second example embodiment of the present disclosure;

FIG. 8 is a block diagram illustrating a hardware configuration example of an information processing apparatus in a third example embodiment of the present disclosure;

FIG. 9 is a block diagram illustrating a configuration example of the information processing apparatus; and

FIG. 10 is a flowchart illustrating an operation example of the information processing apparatus.

### EXAMPLE EMBODIMENT

### First Example Embodiment

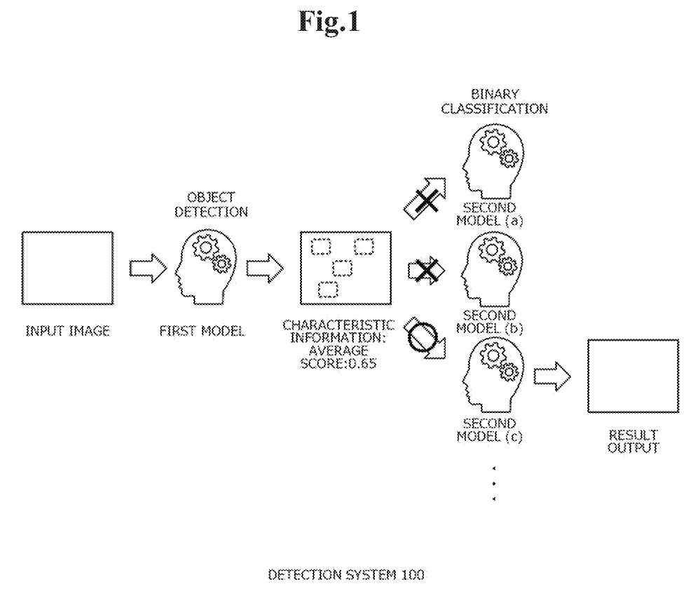

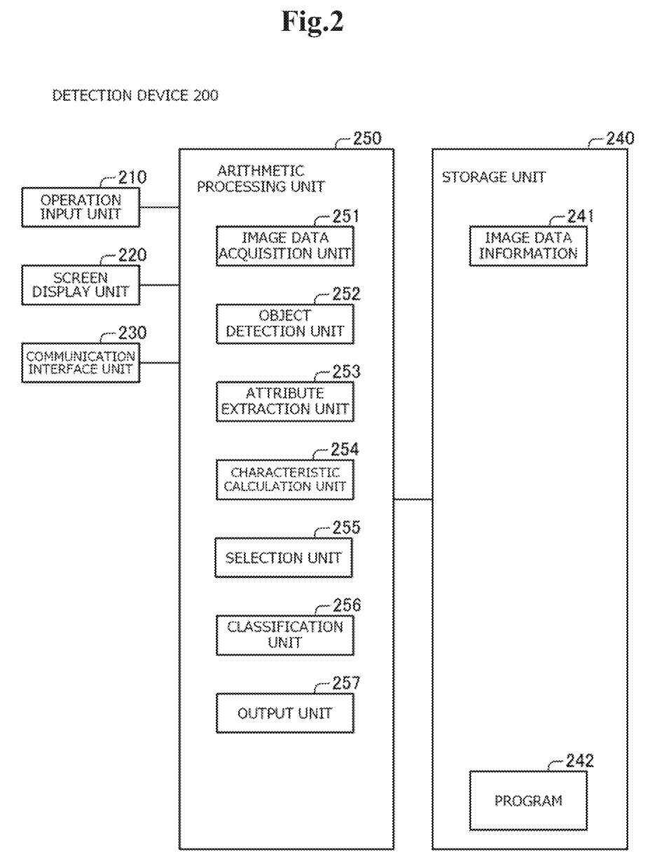

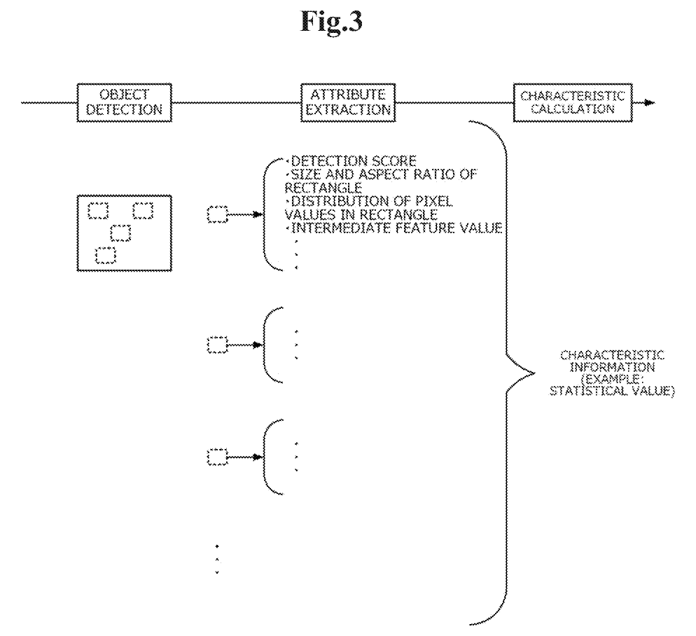

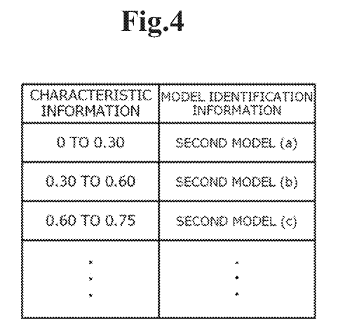

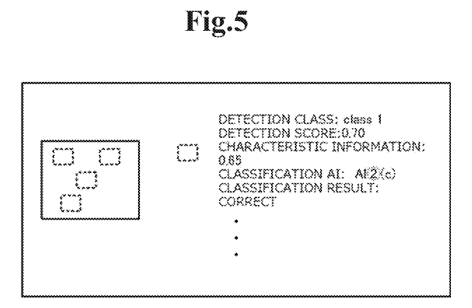

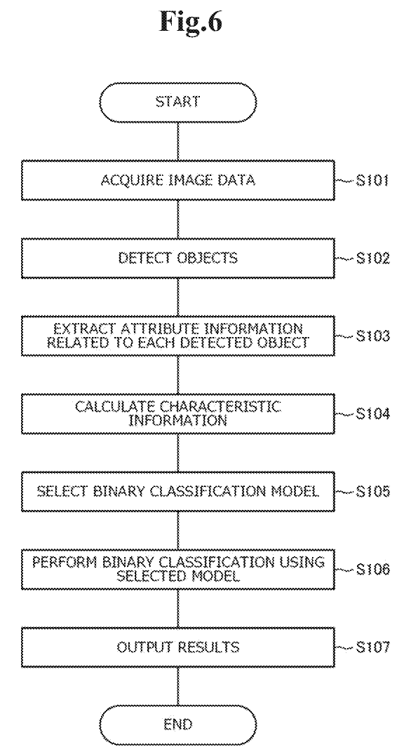

A configuration example of a detection system 100 in the present disclosure will be described with reference to FIGS. 1 to 6. FIG. 1 is a diagram illustrating an outline of the detection system 100. FIG. 2 is a block diagram illustrating a configuration example of a detection device 200. FIG. 3 is a diagram for describing a processing example when characteristic information is calculated. FIG. 4 is a diagram illustrating an example of information used at the time of selection. FIG. 5 is a diagram illustrating an output example by an output unit 257. FIG. 6 is a flowchart illustrating an operation example of the detection device 200. In the present disclosure, the drawings may be associated with one or more example embodiments.

In the present disclosure, the detection system 100 will be described that selects, according to characteristic information that can be calculated using a plurality of detection results by an object detection model that is a first model, a binary classification model that determines whether the detection results by the object detection model are correct. FIG. 1 illustrates the outline of the detection system 100. Referring to FIG. 1, the detection system 100 performs object detection processing on image data that is an input image by using the object detection model that is the first model. At this time, the detection system 100 can perform detection of a plurality of objects from the image data, calculation of a detection score for each object, and the like. The detection system 100 also calculates the characteristic information according to results of the object detection processing. For example, the detection system 100 calculates the characteristic information by calculating an average value of the detection scores related to the detected objects. Thereafter, the detection system 100 selects the binary classification model by using a calculated result. The detection system 100 then performs correctness determination using the selected binary classification model, and outputs results of the determination, and the like.

In the present disclosure, an object to be detected by the object detection model that is the first model is not particularly limited. For example, the object detection model can detect, according to input of the image data, a person, a vehicle, or another optional object to be detected included in the image data. The object detection model may also detect a character string or another optional object to be detected in addition to the case exemplified above.

In the present disclosure, the characteristic information refers to information indicating a characteristic of the object detection model that is the first model. The characteristic information can be calculated according to the results of the object detection processing. For example, the characteristic information may be a statistical value of the detection scores related to the detected objects when the plurality of objects is detected using the object detection model. The characteristic information may also be a statistical value or the like related to at least one of a size or an aspect ratio of a rectangle detected at the time of the object detection, a distribution of pixel values in the rectangle such as a histogram, an optional intermediate feature value calculated when the object detection model performs the object detection, and the like. In addition, the characteristic information may be a statistical value of optional attributes that can be extracted from the detection results. The characteristic information may be at least one of the statistical values exemplified above, and the like. The statistical value may also be an average value, a median value, a standard deviation, or another optional value.

Hereinafter, a configuration of the detection system 100 will be described in more detail. For example, the detection system 100 can include the detection device 200 that is an information processing apparatus that selects the binary classification model that is a second model according to the characteristic information indicating the characteristic of the object detection model that is the first model. The detection device 200 may also include an optional imaging device or the like that acquires image data.

FIG. 2 illustrates a main configuration example of the detection device 200. Referring to FIG. 2, the detection device 200 includes, as main components, an operation input unit 210, a screen display unit 220, a communication interface unit 230, a storage unit 240, and an arithmetic processing unit 250.

In FIG. 2, a case is exemplified where functions as the detection device 200 are achieved using the single information processing apparatus. However, at least some of the functions as the detection device 200 may be achieved using a plurality of the information processing apparatuses, for example, achieved on a cloud. The detection device 200 does not necessarily have to include some of the configuration exemplified above, such as not including the operation input unit 210 or the screen display unit 220, or may include a configuration other than the configuration exemplified above.

The operation input unit 210 includes an operation input device such as a keyboard or a mouse. The operation input unit 210 detects an operation of an operator who operates the detection device 200, and outputs the operation to the arithmetic processing unit 250.

The screen display unit 220 includes a screen display device such as a liquid crystal display or an organic electro-luminescence (EL). The screen display unit 220 can display various types of information stored in the storage unit 240 or the like on a screen, in response to an instruction from the arithmetic processing unit 250.

The communication interface unit 230 includes a data communication circuit or the like. The communication interface unit 230 performs data communication with an imaging device or another optional external device connected via a communication line.

The storage unit 240 is a storage device such as a hard disk or a memory. The storage unit 240 stores processing information necessary for various types of processing of the arithmetic processing unit 250 and a program 242. The program 242 is read and executed by the arithmetic processing unit 250 to achieve various processing units. The program 242 is read from an external device or a recording medium in advance via a data input/output function such as the communication interface unit 230, and is saved in the storage unit 240. Examples of main information stored in the storage unit 240 include image data information 241.

The image data information 241 includes image data to be subjected to first processing using the first model and second processing using the second model. The image data information 241 can be updated by acquisition of image data by an image data acquisition unit 251, or the like.

The arithmetic processing unit 250 includes an arithmetic device such as a central processing unit (CPU) and peripheral circuits of the arithmetic device. The arithmetic processing unit 250 causes the above hardware to cooperate with the program 242 and achieves various processing units by reading and executing the program 242 from the storage unit 240. Examples of the main processing unit achieved by the arithmetic processing unit 250 include the image data acquisition unit 251, an object detection unit 252, an attribute extraction unit 253, a characteristic calculation unit 254, a selection unit 255, a classification unit 256, and the output unit 257.

Instead of the above-described CPU, the arithmetic processing unit 250 may include a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, a combination of these, or the like.

The image data acquisition unit 251 acquires image data to be subjected to the object detection processing or the like from an imaging device, another optional external device, or the like. The image data acquisition unit 251 can store the acquired image data in the storage unit 240 as the image data information 241.

The object detection unit 252 performs the object detection processing of detecting a predetermined object to be detected on the image data acquired by the image data acquisition unit 251. The object detection unit 252 may detect a plurality of the objects to be detected.

For example, the object detection unit 252 inputs the image data to the object detection model that is the predetermined first model. As a result, the object detection model detects predetermined objects from the image data. At this time, the object detection model may generate rectangles or the like surrounding the detected objects. The object detection model can detect the objects, calculate detection scores indicating certainty of the detection, and identify classes to which the objects to be detected belong. For example, by the processing as described above, the object detection unit 252 detects the predetermined objects from the image data and calculates the detection scores. As described above, the object detection unit 252 can detect the plurality of objects from the image data and calculate the detection scores related to the objects.

The attribute extraction unit 253 extracts attribute information related to the objects detected by the object detection unit 252. The attribute extraction unit 253 may extract the attribute information related to each detected object.

For example, as illustrated in FIG. 3, the attribute extraction unit 253 extracts the detection score extracted by the object detection unit 252 as the attribute information. The attribute extraction unit 253 can also extract, as the attribute information, information related to at least one of a size or an aspect ratio of the detected rectangle, a distribution of pixel values in the rectangle such as a histogram, an optional intermediate feature value calculated when the object detection model performs object detection, and the like. In addition to the information exemplified above, the attribute extraction unit 253 may extract the attribute information by performing optional feature extraction processing such as edge detection. For example, the attribute extraction unit 253 can extract at least some pieces of the information exemplified above as the attribute information.

For example, as described above, the attribute extraction unit 253 extracts the attribute information by using results of the detection by the object detection unit 252. The attribute extraction unit 253 may extract optional information as the attribute information by inputting at least one of the image data subjected to the object detection processing and the detection results by the object detection unit 252, or the like to an optional trained model for attribute extraction, for example.

The characteristic calculation unit 254 calculates characteristic information indicating a detection characteristic of the object detection model that is the first model from the attribute information extracted by the attribute extraction unit 253. The characteristic calculation unit 254 can calculate the characteristic information by calculation of a statistical value of the attribute information, and the like.

For example, the characteristic calculation unit 254 calculates, as the characteristic information, a statistical value of the detection scores related to the objects extracted by the attribute extraction unit 253. The characteristic calculation unit 254 may calculate, as the characteristic information, a statistical value or the like related to at least one of the size or the aspect ratio of the rectangle detected at the time of the object detection, the distribution of the pixel values in the rectangle such as the histogram, the optional intermediate feature value calculated when the object detection model performs the object detection, and the like. The characteristic calculation unit 254 may calculate a statistical value related to another optional piece of the attribute information. For example, the characteristic calculation unit 254 can calculate at least some of the statistical values exemplified above. The statistical value may be an average value, a median value, a standard deviation, or another optional value.

For example, as described above, the characteristic calculation unit 254 calculates the characteristic information by using the attribute information related to each detected object (see FIG. 3). The characteristic information may be an optional value other than the statistical value that can be calculated using the attribute information related to each detected object. In a case where a plurality of types of the statistical values is calculated, the characteristic calculation unit 254 may perform optional processing such as vectorization of combining the calculated statistical values into one, or may treat each calculated statistical value as the characteristic information. In other words, the characteristic information may include the plurality of statistical values or the like.

The selection unit 255 selects the binary classification model that performs correctness determination processing that is the second processing on the image data according to a calculation result by the characteristic calculation unit 254. In other words, the selection unit 255 selects the binary classification model that is the second model different from the object detection model according to the calculation result by the characteristic calculation unit 254.

For example, the selection unit 255 can select the binary classification model by referring to a condition stored in advance. FIG. 4 illustrates an example of the condition stored in advance by the selection unit 255. Referring to FIG. 4, the selection unit 255 can include information in which a range of the statistical value that is the characteristic information is associated with model identification information related to each binary classification model, and the like. The selection unit 255 may select the binary classification model by referring to the above information. For example, the selection unit 255 can select the binary classification model by referring to the above information and specifying the model identification information associated with the range to which the characteristic information calculated by the characteristic calculation unit 254 belongs. As an example, it is assumed that the characteristic calculation unit 254 calculates “0.65” as the characteristic information. It is also assumed that the selection unit 255 has the condition as illustrated in FIG. 4. In this case, the selection unit 255 can select a binary classification model of a second model (c) related to a range to which the characteristic information “0.65” belongs.

The selection unit 255 may select the binary classification model by using the class or the like identified by the object detection unit 252 in addition to the calculation result by the characteristic calculation unit 254. Also in this case, the selection unit 255 can select the binary classification model by referring to the condition stored in advance, similarly to the above-described case. For example, the selection unit 255 may select the binary classification model by specifying the model identification information related to the range to which the characteristic information belongs and the identified class with reference to the information stored in advance.

For example, as described above, the selection unit 255 can select the binary classification model by referring to the condition stored in advance. The selection unit 255 may select the binary classification model by using a model trained in advance. For example, the selection unit 255 may select the binary classification model by inputting the calculation result or the like by the characteristic calculation unit 254 to the trained model.

The binary classification model to be selected by the selection unit 255 may be prepared in advance by an optional training device performing training by using training data, or the like. For example, the training device performs the object detection processing using the object detection model that is the first model on training image data prepared in advance. The training device performs clustering using detection scores for results of the object detection processing. As an example, the training device may perform the above clustering by classifying the results of the object detection processing for each range that is the condition when the selection unit 255 performs the selection. Thereafter, the training device can train the binary classification model related to each range by training the model for each cluster. In this manner, the training device can train the model for each condition when the selection unit 255 performs the selection. The function as the training device may be included in the detection device 200 or may be included in an optional information processing apparatus different from the detection device 200.

The classification unit 256 performs classification processing such as correctness determination by using the binary classification model selected by the selection unit 255.

For example, the classification unit 256 inputs the image data, the results of the object detection, and the like to the binary classification model selected by the selection unit 255. As a result, the classification unit 256 determines whether the results of the object detection using the object detection model that is the first model are correct. For example, by the processing as described above, the classification unit 256 performs the correctness determination using the binary classification model selected by the selection unit 255.

The output unit 257 outputs results of the correctness determination by the classification unit 256, and the like. The output unit 257 can display the results of the correctness determination by the classification unit 256, and the like on the screen display unit 220 or transmit the result of the correctness determination by the classification unit 256, and the like to an external device via the communication interface unit 230.

FIG. 5 illustrates an example of the output by the output unit 257. Referring to FIG. 5, the output unit 257 can output information according to the selection by the selection unit 255, and the like together with the results of the correctness determination by the classification unit 256. For example, the output unit 257 may output, as the information according to the selection by the selection unit 255, at least some of information indicating the selected binary classification model, the characteristic information, information serving as a basis for the selection of the identified class, and the like. The output unit 257 may output information indicating the results of the object detection processing using the object detection model, such as the detection score, or the like. In addition to the information exemplified above, the output unit 257 may output optional information such as outputting the detected rectangle superimposed and displayed on the image data.

The above is the configuration example of the detection device 200. Subsequently, referring to FIG. 6, the operation example of the detection device 200 will be described. FIG. 6 illustrates the operation example of the detection device 200, and operation of the detection device 200 is not limited to the case exemplified in FIG. 6.

FIG. 6 is a flowchart illustrating the operation example of the detection device 200. Referring to FIG. 6, the image data acquisition unit 251 acquires image data from an imaging device, another optional external device, or the like (step S101).

The object detection unit 252 performs the object detection processing of detecting a predetermined object to be detected on the image data acquired by the image data acquisition unit 251 (step S102). The object detection unit 252 may detect a plurality of the objects to be detected.

The attribute extraction unit 253 extracts attribute information related to the objects detected by the object detection unit 252 (step S103). The attribute extraction unit 253 may extract the attribute information related to each detected object.

The characteristic calculation unit 254 calculates characteristic information indicating a detection characteristic of the object detection model that is the first model from the attribute information extracted by the attribute extraction unit 253 (step S104). The characteristic calculation unit 254 may calculate the characteristic information by calculation of a statistical value of the attribute information, and the like.

The selection unit 255 selects the binary classification model that performs the correctness determination processing that is the second processing on the image data according to a calculation result by the characteristic calculation unit 254 (step S105).

For example, the selection unit 255 can select the binary classification model by referring to a condition stored in advance.

The classification unit 256 performs the classification processing such as the correctness determination by using the binary classification model selected by the selection unit 255 (step S106).

The output unit 257 outputs results of the correctness determination by the classification unit 256, and the like (step S107). The output unit 257 can display the results of the correctness determination by the classification unit 256, and the like on the screen display unit 220 or transmit the result of the correctness determination by the classification unit 256, and the like to an external device via the communication interface unit 230. The output unit 257 may output information according to the selection by the selection unit 255, and the like together with the results of the correctness determination by the classification unit 256.

The above is the operation example of the detection device 200.

In this manner, the detection device 200 includes the characteristic calculation unit 254 and the selection unit 255. According to such a configuration, the selection unit 255 can select the binary classification model that performs the correctness determination processing that is the second processing on the image data according to the calculation result by the characteristic calculation unit 254. As a result, the detection device 200 can select the more appropriate model using the plurality of detection results. The detection device 200 can perform the classification processing such as the correctness determination that is the second processing by using the selected binary classification model.

### Second Example Embodiment

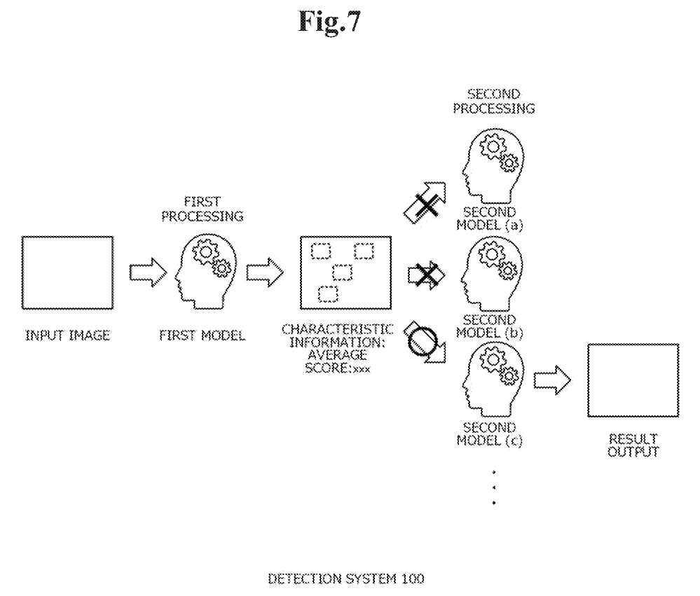

Subsequently, a modification of the detection system 100 will be described with reference to FIG. 7. In the first example embodiment, as illustrated in FIG. 1, the object detection processing using the object detection model that is the first model is performed as the first processing, and the classification processing such as the correctness determination using the binary classification model that is the second model is performed as the second processing. However, the first processing and the second processing are not limited to the object detection processing and the classification processing. In other words, the first model and the second model may be other than the object detection model and the binary classification model. For example, as illustrated in FIG. 7, the detection system 100 may select a second model that performs optional second processing according to characteristic information that can be calculated according to a plurality of first processing results by an optional first model.

For example, the detection system 100 can perform object detection processing as first processing and perform the object detection processing as the second processing.

In this case, the detection system 100 can use a predetermined object detection model as the first model and select an object detection model to be used as the second model from among a plurality of object detection models. At this time, the object detection model used as the first model may or may not be included in the candidate models of the second model. The detection system 100 may perform segmentation processing, skeleton estimation processing, and the like as the first processing, and perform classification processing and the like as the second processing. In this manner, the first processing using the first model and the second processing using the second model may be optionally set.

### Third Example Embodiment

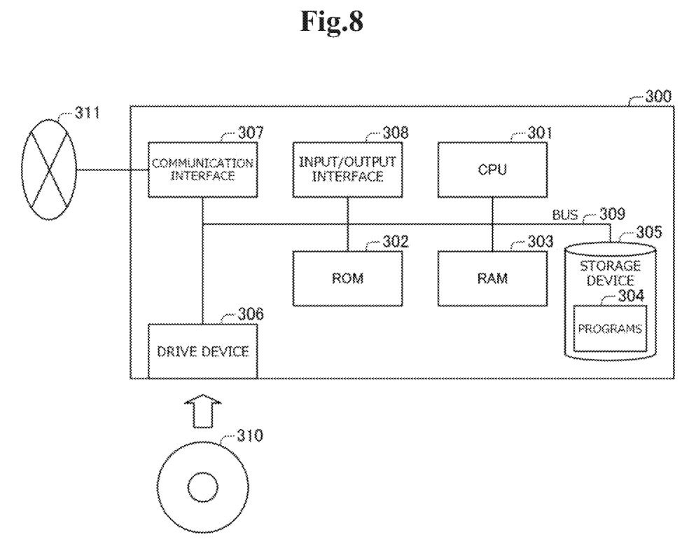

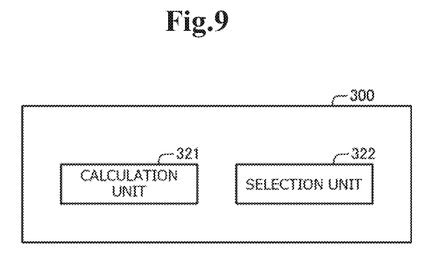

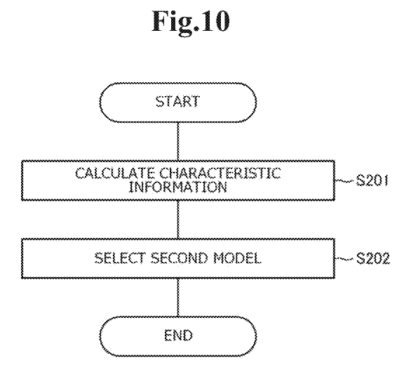

Next, an information processing apparatus 300 that is a modification of the detection device 200 will be described with reference to FIGS. 8 to 10. FIG. 8 is a diagram illustrating a hardware configuration example of the information processing apparatus 300. FIG. 9 is a block diagram illustrating a configuration example of the information processing apparatus 300. FIG. 10 is a flowchart illustrating an operation example of the information processing apparatus 300.

The information processing apparatus 300 is an apparatus that selects a second model according to calculated characteristic information. FIG. 8 illustrates the hardware configuration example of the information processing apparatus 300. Referring to FIG. 8, the information processing apparatus 300 has the following hardware configuration, as an example.

A central processing unit (CPU) 301 (arithmetic device)

A read only memory (ROM) 302 (storage device)

A random access memory (RAM) 303 (storage device)

Programs 304 loaded into the RAM 303

A storage device 305 storing the programs 304

A drive device 306 that reads and writes a recording medium 310 outside the information processing apparatus 300

A communication interface 307 connected to a communication network 311 outside the information processing apparatus 300

An input/output interface 308 for inputting/outputting data

A bus 309 for connecting each component

The information processing apparatus 300 can achieve functions as a calculation unit 321 and a selection unit 322 illustrated in FIG. 9 by the CPU 301 acquiring the programs 304 and executing the programs 304. The programs 304 are stored in, for example, the storage device 305 or the ROM 302 in advance, and the CPU 301 loads and executes the programs 304 on the RAM 303 or the like as necessary. The programs 304 may be supplied to the CPU 301 via the communication network 311, or may be stored in the recording medium 310 in advance, and read and supplied by the drive device 306 to the CPU 301.

FIG. 8 illustrates the hardware configuration example of the information processing apparatus 300. The hardware configuration of the information processing apparatus 300 is not limited to the above-described case. For example, the information processing apparatus 300 may include a part of the above-described configuration, such as not including the drive device 306. The CPU 301 may be a GPU exemplified in the first example embodiment, or the like.

The calculation unit 321 calculates characteristic information indicating a detection characteristic of a predetermined first model according to a plurality of processing results for image data using the first model.

For example, the calculation unit 321 acquires the processing results from a first processing unit or the like that performs processing using the first model on the image data. The calculation unit 321 may acquire the plurality of processing results for the image data, such as acquiring results of detecting a plurality of objects in a case where object detection is performed as the processing using the first model. The calculation unit 321 calculates the characteristic information according to the plurality of acquired processing results. The calculation unit 321 may calculate the characteristic information by using an optional method such as calculating the characteristic information by calculating a statistical value from the processing results.

The function as the first processing unit that performs the processing using the first model may be included in the information processing apparatus 300 or may be included in an external information processing apparatus different from the information processing apparatus 300.

The selection unit 322 selects a second model that performs predetermined processing on the image data according to a calculation result by the calculation unit 321. For example, the selection unit 322 can select the second model by confirming which of predetermined conditions the characteristic information calculated by the calculation unit 321 corresponds to. The selection unit 322 may select the second model by using an optional trained model trained in advance. The processing performed by the second model may be the same as or different from the processing performed by the first model.

The above is the configuration example of the information processing apparatus 300. The information processing apparatus 300 may have the function as the first processing unit as described above. The information processing apparatus 300 may also have a function as a second processing unit that performs the predetermined processing on the image data using the second model selected by the selection unit 322. Subsequently, the operation example of the information processing apparatus 300 will be described with reference to FIG. 10. However, the operation of the information processing apparatus 300 is not limited to the case exemplified in FIG. 10.

FIG. 10 is the flowchart illustrating the operation example of the information processing apparatus 300. Referring to FIG. 10, the calculation unit 321 calculates characteristic information indicating a detection characteristic of the predetermined first model according to a plurality of processing results for image data using the first model (step S201). The calculation unit 321 may calculate the characteristic information by using an optional method.

The selection unit 322 selects the second model that performs predetermined processing on the image data according to a calculation result by the calculation unit 321 (step S202). The selection unit 322 may select the second model by, for example, confirming which of predetermined conditions the characteristic information calculated by the calculation unit 321 corresponds to.

The above is the operation example of the information processing apparatus 300.

In this manner, the information processing apparatus 300 includes the calculation unit 321 and the selection unit 322. According to such a configuration, the selection unit 322 can select the second model that performs the predetermined processing on the image data according to the calculation result by the calculation unit 321. As a result, the information processing apparatus 300 can select the more appropriate model using the plurality of processing results.

The above-described information processing apparatus 300 can be achieved by incorporating a predetermined program into an apparatus such as the information processing apparatus 300. Specifically, the program that is another mode of the present disclosure is a program for causing the apparatus such as the information processing apparatus 300 to achieve the processing of calculating, according to the plurality of processing results for the image data using the predetermined first model, the characteristic information indicating the detection characteristic of the first model, and selecting, according to the calculation result, the second model that performs the predetermined processing on the image data.

An information processing method executed by the apparatus such as the above-described information processing apparatus 300 is the method in which the apparatus such as the information processing apparatus 300 calculates, according to the plurality of processing results for the image data using the predetermined first model, the characteristic information indicating the detection characteristic of the first model, and selects, according to the calculation result, the second model that performs the predetermined processing on the image data.

Since the program, a computer readable recording medium recording the program, the information processing method, or the like having the above-described configuration can achieve operations and effects similar to those of the above-described information processing apparatus 300, the above-described object of the present disclosure can be achieved.

### Supplementary Note

Some or all of the above example embodiments may also be described as in the following Supplementary Notes. Hereinafter, an outline of the information processing apparatus and the like in the present disclosure will be described. However, the present disclosure is not limited to the following configuration.

### Supplementary Note 1

An information processing apparatus including:

a calculation unit that calculates, according to a plurality of processing results for image data using a predetermined first model, characteristic information indicating a detection characteristic of the first model; and

a selection unit that selects, according to a calculation result by the calculation unit, a second model that performs predetermined processing on the image data.

### Supplementary Note 2

The information processing apparatus according to Supplementary Note 1, further including:

a processing unit that performs processing using the selected second model; and

an output unit that outputs a result of the processing by the processing unit,

in which the output unit outputs information according to the selection by the selection unit together with the result of the processing by the processing unit.

### Supplementary Note 3

The information processing apparatus according to Supplementary Note 2, in which

the output unit outputs, as the information according to the selection by the selection unit, at least one of information indicating the selected second model and information serving as a basis for the selection.

### Supplementary Note 4

The information processing apparatus according to any one of Supplementary Notes 1 to 3, in which

the first model performs object detection processing of detecting an object from the image data and calculating a detection score, and

the calculation unit calculates, as the characteristic information, a statistical value of detection scores when a plurality of objects is detected from the image data.

### Supplementary Note 5

The information processing apparatus according to Supplementary Note 4, in which

the calculation unit calculates, as the characteristic information, a statistical value related to at least one of a size of a rectangle detected by the object detection processing, a distribution of pixel values in the rectangle, and an intermediate feature value when object detection is performed, together with the statistical value of the detection scores.

### Supplementary Note 6

The information processing apparatus according to Supplementary Note 4 or 5, in which

the first model detects the object from the image data and identifies a class to which the detected object belongs, and

the selection unit selects the second model according to the calculation result by the calculation unit and a result of the identification of the class.

### Supplementary Note 7

The information processing apparatus according to any one of Supplementary Notes 4 to 6, in which

the selection unit is configured to select the second model related to a range to which the statistical value indicated by the characteristic information belongs, and

the second model performs training using training data related to the range.

### Supplementary Note 8

The information processing apparatus according to any one of Supplementary Notes 1 to 7, further including

an extraction unit that extracts predetermined attribute information according to a result of processing by the first model,

in which the calculation unit calculates the characteristic information by using the attribute information extracted by the extraction unit.

### Supplementary Note 9

An information processing method by an information processing apparatus, the information processing method including:

calculating, according to a plurality of processing results for image data using a predetermined first model, characteristic information indicating a detection characteristic of the first model; and

selecting, according to a calculation result, a second model that performs predetermined processing on the image data.

### Supplementary Note 10

A program for causing an information processing apparatus to achieve processing of:

calculating, according to a plurality of processing results for image data using a predetermined first model, characteristic information indicating a detection characteristic of the first model; and

selecting, according to a calculation result, a second model that performs predetermined processing on the image data.

Some or all of the configurations described in Supplementary Notes 2 to 8 dependent on the information processing apparatus described in Supplementary Note 1 can also be dependent on the information processing method described in Supplementary Note 9 and the program described in Supplementary Note 10 by the same dependency relationship as Supplementary Notes 2 to 8. Some or all of the configurations described as Supplementary Notes can be similarly dependent on not only Supplementary Notes 9 and 10, but also various pieces of hardware and software, various types of recording means for recording software, methods, programs, or systems without departing from the above-described example embodiments.

The program described in the example embodiments and Supplementary Notes described above can be stored using various types of non-transitory computer readable media and supplied to a computer. The non-transitory computer readable media include various types of tangible storage media. Examples of the non-transitory computer readable media include a magnetic recording medium (for example, a flexible disk, a magnetic tape, or a hard disk drive), an optical magnetic recording medium (for example, a magneto-optical disk), a compact disc-read only memory (CD-ROM), a CD-R, a CD-R/W, and a semiconductor memory (for example, a mask ROM, a programmable ROM (PROM), an erasable PROM (EPROM), a flash ROM, or a random access memory (RAM)). The program may be supplied to the computer by various types of transitory computer readable media. Examples of the transitory computer readable media include electrical signals, optical signals, and electromagnetic waves. The transitory computer readable media can supply the programs to the computer via a wired communication path such as an electric wire and an optical fiber, or a wireless communication path.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with other embodiments.

### REFERENCE SIGNS LIST

100 detection system

200 detection device

210 operation input unit

220 screen display unit

230 communication interface unit

240 storage unit

241 image data information

242 program

250 arithmetic processing unit

251 image data acquisition unit

252 object detection unit

253 attribute extraction unit

254 characteristic calculation unit

255 selection unit

256 classification unit

257 output unit

300 information processing apparatus

301 CPU

302 ROM

303 RAM

304 programs

305 storage device

306 drive device

307 communication interface

308 input/output interface

309 bus

310 recording medium

311 communication network

321 calculation unit

322 selection unit

1. An information processing apparatus comprising:
at least one memory configured to store processing instructions; and
at least one processor configured to execute the processing instructions to:
calculate, according to a plurality of processing results for image data using a predetermined first model, characteristic information indicating a detection characteristic of the first model; and
select, according to a calculation result, a second model that performs predetermined processing on the image data.

2. The information processing apparatus according to claim 1, wherein the at least one processor is configured to execute the processing instructions to:
perform processing using the selected second model;
output a result of the processing; and
output information according to the selection together with the result of the processing.

3. The information processing apparatus according to claim 2, wherein the at least one processor is configured to execute the processing instructions to
output, as the information according to the selection, at least one of information indicating the selected second model and information serving as a basis for the selection.

4. The information processing apparatus according to claim 1, wherein
the first model performs object detection processing of detecting an object from the image data and calculating a detection score, and
the at least one processor is configured to execute the processing instructions to calculate, as the characteristic information, a statistical value of detection scores when a plurality of objects is detected from the image data.

5. The information processing apparatus according to claim 4, wherein the at least one processor is configured to execute the processing instructions to
calculate, as the characteristic information, a statistical value related to at least one of a size of a rectangle detected by the object detection processing, a distribution of pixel values in the rectangle, and an intermediate feature value when object detection is performed, together with the statistical value of the detection scores.

6. The information processing apparatus according to claim 4, wherein
the first model detects the object from the image data and identifies a class to which the detected object belongs, and
the at least one processor is configured to execute the processing instructions to select the second model according to the calculation result and a result of the identification of the class.

7. The information processing apparatus according to claim 4, wherein
the at least one processor is configured to execute the processing instructions to select the second model related to a range to which the statistical value indicated by the characteristic information belongs, and
the second model performs training using training data related to the range.

8. The information processing apparatus according to claim 1, wherein the at least one processor is configured to execute the processing instructions to:
extract predetermined attribute information according to a result of processing by the first model; and
calculate the characteristic information by using the extracted attribute information.

9. An information processing method by an information processing apparatus, the information processing method comprising:
calculating, according to a plurality of processing results for image data using a predetermined first model, characteristic information indicating a detection characteristic of the first model; and
selecting, according to a calculation result, a second model that performs predetermined processing on the image data.

10. A computer readable storage medium storing a program for causing an information processing apparatus to achieve processing of:
calculating, according to a plurality of processing results for image data using a predetermined first model, characteristic information indicating a detection characteristic of the first model; and
selecting, according to a calculation result, a second model that performs predetermined processing on the image data.
